(19) United States
(12) Patent Application Publication
(10) Pub. No.: US 2023/0134740 A1
(43) Pub. Date: May 4, 2023

(54) NUT FOR SECURING A COMPONENT TO A SUPPORT

(71) Applicant: BLANCO GMBH + CO KG, Oberderdingen (DE)

(72) Inventor: Stefan KELLER, Zaberfeld (DE)

(73) Assignee: BLANCO GMBH + CO KG, Oberderdingen (DE)

(21) Appl. No.: 17/976,160

(22) Filed: Oct. 28, 2022

(30) Foreign Application Priority Data
Oct. 29, 2021 (DE) 10 2021 212 266.3

(51) Int. Cl. E03C 1/04; F16B 37/08

(52) U.S. Cl. CPC E03C 1/0401; F16B 37/0857

(57) ABSTRACT

The invention relates to a nut for securing a component to a support, in particular a sanitary faucet to a countertop, comprising a first nut part and a second nut part, wherein the first nut part has at least two threaded lugs, which have a thread on their radially inner face, wherein the threaded lugs are arranged projecting radially outward at a first angle, and wherein the two nut parts are arranged in an axially displaceable manner relative to each other such that in a first position—open position—, the threaded lugs of the first nut part are arranged projecting radially outward and that in a second position—closed position—, the threaded lugs of the first nut part are pressed radially inward by means of the second nut part for engaging with a matching male thread of the component.

The invention relates to a nut for securing a component to a support, in particular a sanitary faucet to a countertop, comprising a first nut part and a second nut part, wherein the first nut part has at least two threaded lugs, which have a thread on their radially inner face.

The invention further relates to a system for securing a component to a support, comprising a nut.

The invention further relates to a method of securing a component to a support.

The invention also relates to a method for removing a component secured to a support.

Although applicable to any component, this invention is described with respect to components in the form of sanitary faucets.

Although applicable to any support, this invention is described with respect to supports in the form of countertops.

Sanitary faucets have become known in a variety of ways. They are typically secured to a countertop by having a suitable faucet shaft of the sanitary faucet extend partially through a countertop mounting hole. To secure the sanitary faucet, the faucet shaft has a male thread onto which a nut is screwed.

The problem here is that the faucet shaft is often long, so that it may also be used with different thicknesses of the countertop. When installing the sanitary faucet, for thin countertops, it is then laborious and time-consuming to apply the nut to the male thread of the threaded shaft up to the final secured position.

From EP 3 786 374 A1, a nut has become known that has yielding threaded lugs that permit the nut to be pushed up to its final position and in that way permit the sanitary faucet to be secured to the support more quickly. The problem here, however, is that the nut has a complicated design and once the sanitary faucet has been secured in place, it is very difficult or time-consuming to remove it, if at all, because it is not possible to simply slide it over the shaft in the direction of disassembly.

Therefore, an object of this invention is to provide a nut for securing a component to a support and a system for securing a component to a support, which are simple and inexpensive to manufacture, permit the component to be secured and removed easily and quickly, and reduce the operating space required for an assembler to install the component.

A further object of this invention is to specify an alternative nut for securing a component to a support and an alternative system for securing a component to a support.

A further object of this invention is to provide a method for securing a component to a support and a method for removing a component secured to a support, which can be performed easily, quickly and reliably with reduced operating space required for assembly for an installer.

A further object of this invention is to disclose an alternative method for securing a component to a support and an alternative method for removing a component secured to a support.

In an embodiment, this invention solves the above-mentioned problems using a nut for securing a component to a support, in particular a sanitary faucet to a countertop, comprising a first nut part and a second nut part, wherein the first nut part has at least two threaded lugs, which have a thread on their radially inner face, wherein the threaded lugs are arranged projecting radially outward at a first angle, and wherein the two nut parts are arranged in an axially displaceable manner relative to each other such that in a first position—open position —, the threaded lugs of the first nut part are arranged projecting radially outward and that in a second position—closed position —, the threaded lugs of the first nut part are pressed radially inward by means of the second nut part for engaging with a matching male thread of the component.

In a further embodiment, this invention solves the above problems using a system for securing a component to a support, comprising a nut according to any one of the claims 1-15, wherein the component has a male thread, which matches the thread of the nut, such that in its closed position the nut can be screwed onto the male thread, and wherein in its open position the thread has, at least in one area, an internal diameter that is greater than the external diameter of the male thread.

In a further embodiment, this invention solves the problems listed above using a method for securing a component to a support, comprising the steps
providing a nut according to any one of the claims 1-15 in the open position,
providing the component, wherein the component has a male thread matching the thread of the nut such that in its closed position the nut can be screwed onto the male thread,
arranging of the component on the support,
sliding the nut in its open position over the male thread of the component until the second nut part of the nut is in contact with the support,
actuating the first nut part until the nut is in its closed position to engage with the thread in the male thread of the component, and
actuating the thread of the nut by turning the nut to secure the component to the support.

In a further embodiment, this invention solves the problems listed above using a method for removing a component secured to a support, comprising the steps
providing a nut according to any one of the claims 1-15 in its closed position at the component, wherein the component has male threads matching the threads of the nut, and wherein the threads of the nut engage with the male threads of the component,
actuating the thread of the nut by rotating the nut to remove the component from the support until the nut is in its open position, and
sliding the nut in its open position over the male thread of the component to remove the component from the support.

One of the advantages achieved in this way is a simplified assembly of components on supports by means of the nut. Another advantage is that during assembly, the nut is forced from its open position to its closed position in a substantially self-locking manner, and that in this way rapid assembly is made possible using a few simple steps. Another advantage is the simple and inexpensive production of the two nut parts, for instance from plastic, preferably by injection molding.

Further features, advantages and further embodiments of the invention are described below or may be disclosed in that way.

According to a preferred embodiment, the first and second nut parts are secured to each other by means of a securing device, which in particular is designed to be detachable. The advantage is a flexible and simple securing of the two nut parts to each other, for instance to provide limited axial displacement.

According to a further preferred embodiment, the securing device comprises a latching, clipping or snapping device. The advantage thereof is a simple and quick securing of the two nut parts to each other.

According to a further preferred embodiment, a return device is arranged, which exerts a return force in the direction of the open position. This ensures that the nut can be easily loosened, for instance if the component is to be replaced for maintenance purposes. If the nut is actuated accordingly, the nut “automatically” moves to its open position for it to be pulled off quickly and easily, for instance from a sanitary faucet shaft.

According to a further preferred embodiment, the return device comprises a spring device having at least one spring arranged between the first nut part and the second nut part. The advantage thereof is a simple and reliable provision of a return force.

According to a further preferred embodiment, the return device comprises matching surfaces at the first and second nut parts, which can slide along each other and are beveled at a second angle with respect to the axial direction. The advantage thereof is that no additional component, such as a spring, is required, reducing the manufacturing costs of the nut.

According to a further preferred embodiment, the second angle is greater than the first angle. This provides sufficient return force without the threaded lugs having to project far radially outward.

According to a further preferred embodiment, the second angle relative to the axial direction is at least 5 degrees, in particular at least 10 degrees, preferably at least 15 degrees, in particular at least 30 degrees. This provides a sufficiently large return force without significantly increasing the installation space for the nut.

According to a further preferred embodiment, the first angle of the threaded lugs relative to the axial direction is at least 0.1 degrees, in particular at least 0.5 degrees, preferably at least 1 degree, in particular at least 3 degrees. This provides sufficient spacing of the thread to slide the nut over a matching male thread, while at the same time keeping radial installation space to a minimum.

According to a further preferred embodiment, the number of threaded lugs is less than 30, preferably less than 15, in particular less than 8, preferably 4. This provides a sufficient number of threaded lugs while maintaining a reliable engagement in the closed position.

According to a further preferred embodiment, thread flanks of the thread of at least one of the threaded lugs, in particular of every threaded lug, are shortened in the area facing away from the end area of the at least one threaded lug, in particular wherein the area comprises more than one thread flank and/or less than 5 thread flanks, preferably 2 thread flanks of the thread. This makes for improved sliding of the nut over a matching male thread.

According to a further preferred embodiment, a guide device is arranged for the defined guidance of the first and second nut parts along each other, in particular wherein the guide device is designed as a locating device. The advantage thereof is a defined guidance of the two nut parts along each other, which simplifies the handling of the nut, in particular during assembly.

According to a further preferred embodiment, the guide device comprises a link device having at least one link and one link element, in particular wherein the link element is arranged at the first nut part. In this way, provision is made for a simple and at the same time reliable guidance of the two nut parts.

According to a further preferred embodiment, several links having link elements are arranged, in particular wherein the number is more than 3 and less than 6, preferably 4. This provides adequate guidance for the two nut parts.

According to a further preferred embodiment, the at least one link element and the link are each rounded. The advantage thereof is less wear on the guide device and improved handling of the nut.

According to a further preferred embodiment, in the open position of the nut the thread has, at least in one area, an inside diameter which is smaller than or equal to the outside diameter of the male thread. The advantage thereof is that, on the one hand, the nut can be slid on easily without turning, because the thread can essentially slide over the male thread, but at the same time it ensures that in the final assembly position of the nut, the thread can engage directly with the male thread. No additional axial forces to be exerted from the outside in the mounting direction are required, simplifying installation overall.

Further important features and advantages of the invention are described in more detail in the dependent claims, in the drawings, and in the accompanying figure description based on the drawings.

It should be understood that the features mentioned above and those to be explained below can be used not only in the combination indicated in each case, but also in other combinations or on their own, without departing from the scope of this invention.

Preferred embodiments and embodiments of this invention are shown in the drawings and will be explained in more detail in the following description, wherein identical reference numerals refer to identical or similar or functionally identical components or elements.

In the Figures

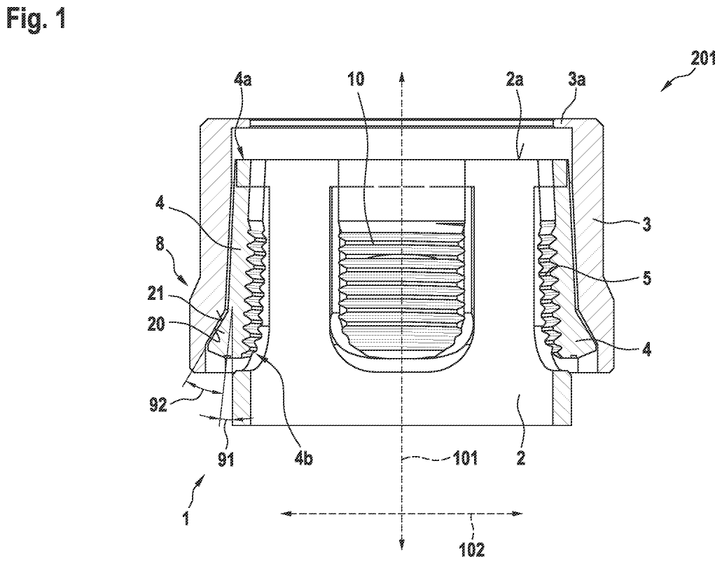

FIG. 1 shows a cross-section of a nut according to an embodiment of this invention in an open position;

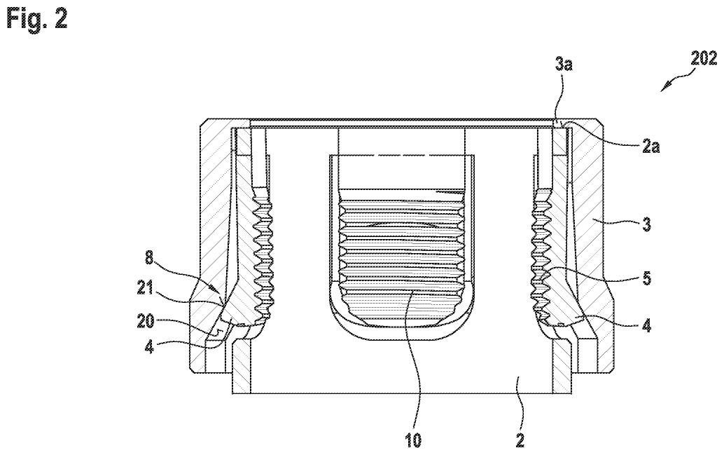

FIG. 2 shows a cross-section of the nut according to FIG. 1 in a closed position;

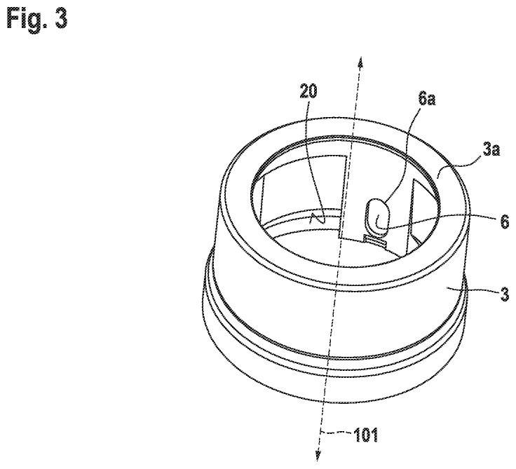

FIG. 3 shows a perspective view of a second nut part of a nut according to an embodiment of this invention;

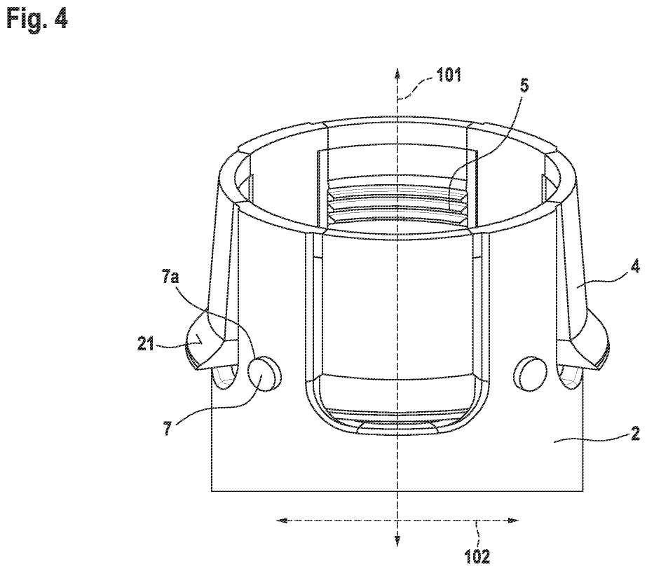

FIG. 4 shows a perspective view of a first nut part of a nut according to an embodiment of this invention;

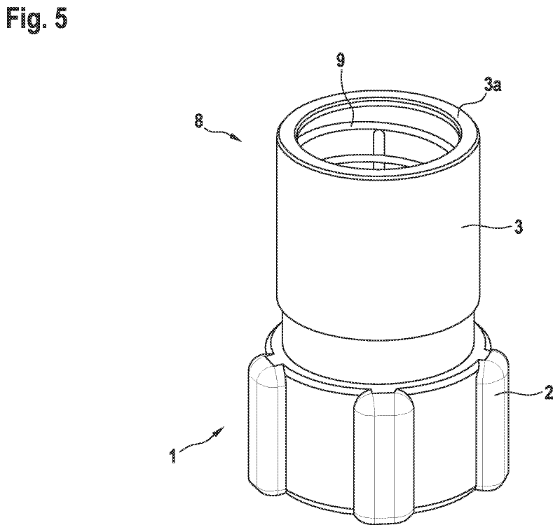

FIG. 5 shows a perspective view of a nut according to an embodiment of this invention in an open position;

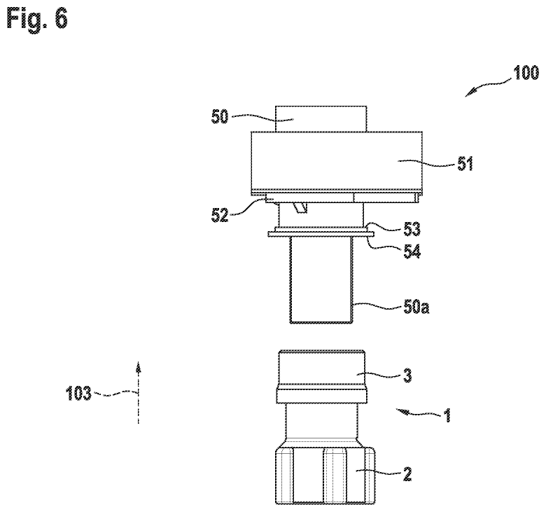

FIG. 6 shows a system according to an embodiment of this invention;

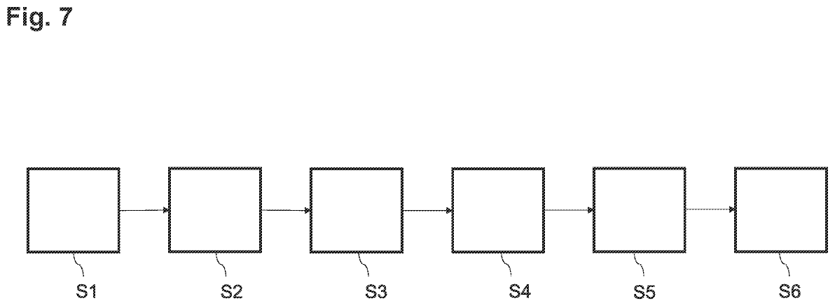

FIG. 7 shows a schematic representation of steps of a method according to an embodiment of this invention; and

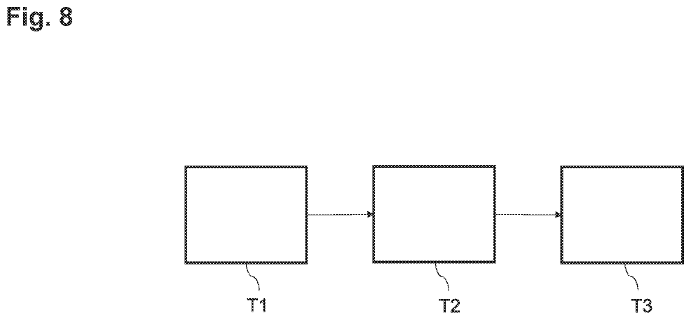

FIG. 8 shows a schematic representation of steps of a method according to an embodiment of this invention.

FIG. 1 shows a cross-section of a nut according to an embodiment of this invention in an open position and FIG. 2 shows a cross-section of the nut according to FIG. 1 in a closed position.

In FIGS. 1 and 2, a nut 1 is shown in its open position 201—FIG. 1—and in its closed position 202—FIG. 2. To this end, the nut 1 comprises a first nut part 2 and a second nut part 3. Both nut parts 2, 3 are circular in cross-section. The first nut part 2 further has threaded lugs 4 that are formed to protrude in the radial direction 102 by a first angle 91. Essentially, in cross-section this results in a triangular shape of the threaded lugs 4, wherein an initial area 4a of a threaded lug 4 is disposed mainly directly on the surface of the first nut part 2 and an end area 4b is spaced apart from the surface of the first nut part 2.

In the end area 4b of the relevant threaded lug 4, a sliding surface 21 is arranged on the radially outer surface of the latter, which is inclined radially outward with respect to the axial direction 101 by a second angle 92, which is greater than the first angle 91.

The second nut part 3—like the first nut part 2—is essentially formed as a hollow cylinder, wherein the inner diameter of the second nut part 3 is such that the second nut part 3 can be arranged above the first nut part 2. In FIGS. 1 and 2, the second nut part 3 has a circumferential projection 3a projecting radially inward on its upper rim, which is used as a stop for the upper rim surface 2a of the first nut part 2 (see FIG. 2). Further, the second nut part 3 has a surface 20 on its radially inner face matching the surface 21 of the first nut part 2, wherein the surfaces 20, 21 are arranged relative to each other such that they can slide along each other when the two nut parts 2, 3 move relative to each other in the axial direction 101.

If the first nut part 2 is now pushed further into the second nut part 3, in other words if the upper rim surface 2a moves towards the projection 3a, the surfaces 20, 21 slide along each other. The angle 92 of the surfaces 20, 21 relative to each other thus presses the threaded lugs 4 radially inward, for the thread 5 of the threaded lugs 4 to come into engagement with a male thread of a component arranged in the first nut part 2. In the closed position 202, the upper rim surface 2a is directly at the projection 3a and the threaded lugs 4 are pressed inward. The angle 91 of the threaded lugs 4, due to the force exerted by the second nut part 3, is then at least 0 degrees, and is in particular even negative, for instance −1.3 degrees, to compensate for spring effects of the materials, depending on the material of the nut parts.

The thread 5 of the threaded lugs 4 may be abraded in the area adjacent to the initial area 4a, i.e., one or more threads 10 are shortened to provide little overlap with a male thread of a component, which makes it easier to slide the nut 1 onto a matching male thread of a component.

FIG. 3 shows a perspective view of a second nut part of a nut according to an embodiment of this invention, and FIG. 4 shows a perspective view of a first nut part of a nut according to an embodiment of this invention.

FIG. 3 shows a second nut part 3 having an upper rim 3a. Inside the second nut part 3, an elongated recess 6 is shown in the axial direction 101, the end areas of which are rounded (reference numeral 6a). The recess 6 is used here as a link for a link element 7, which is also rounded (reference numeral 7a) and is designed, for instance, in the form of a cylinder extending in the radial direction 102, as shown in FIG. 4. The links 6 and link elements 7 are arranged in areas outside the threaded lugs 4 and surfaces 20, 21, respectively. By means of the link guide 6, 7, a defined motion in the axial direction 101 of the two nut parts 2, 3 along each other is possible. For this purpose, a total of four links 6 having link elements 7, which can be arranged symmetrically in the circumferential direction, are arranged.

FIG. 5 shows a perspective view of a nut according to an embodiment of this invention in an open position.

FIG. 5 shows a nut 1 having two nut parts 2, 3. Essentially, they have the same structure as the nut parts 2, 3 of FIGS. 1 and 2. In contrast to the nut parts 2, 3 of FIGS. 1 and 2, the return device 8 is not formed by beveled surfaces 20, 21. Instead, to provide a return force, a spring 9 is arranged between the axial inner face of the circumferential projection 3a of the second nut part 3 and the upper rim surface 2a (not shown) of the first nut part 2. The diameter of the spring 9 thus essentially matches the inner diameter of the second nut part 3.

FIG. 6 shows a system according to an embodiment of this invention.

FIG. 6 shows a cross-section of a system 100. In this regard, the system 100 includes a sanitary faucet 50 to be secured to a countertop 51. For this purpose, an opening (not shown) is arranged in the countertop 51 through which a shaft of the sanitary faucet 50 having a male thread 50a projects.

To secure the sanitary faucet 50, a stabilizing triangle 52 and a rubber washer 53 and a metal washer 54 are first applied to the shaft in the usual manner. Subsequently, the nut 1 is pushed onto the shaft in its open position in the assembly direction 103 up to the metal washer 54, wherein the rim surface 2a and projection 3a are still spaced apart. The thread 5 of the threaded lugs 4 covers part of the male thread, even when it is being slid onto the shaft. In this way, when the nut 1 is subsequently actuated, a force is generated in the assembly direction 103 and the nut 1 is brought into its closed position 202. In other words, the second nut part 3 is moved relative to the first nut part 2 and the rim surface 2a and the projection 3a move towards each other until they are then brought into contact with each other by further actuation of the nut 1. Thus, the threads of the nut 1 engage with the male threads 50a and the nut 1 can be screwed onto the male threads 50a of the shaft of the sanitary faucet 50.

FIG. 7 shows a schematic representation of steps of a method according to an embodiment of this invention.

FIG. 7 shows steps of a method for securing a component to a support.

The method comprises the steps:
providing S1 a nut according to any one of the claims 1-15 in the open position,
providing S2 the component, wherein the component has a male thread matching the thread of the nut such that in its closed position the nut can be screwed onto the male thread,
arranging S3 of the component at the support,
sliding S4 the nut in its open position over the male thread of the component until the second nut part of the nut is in contact with the support,
actuating S5 the first nut part until the nut is in its closed position to engage with the thread in the male thread of the component, and
actuating S6 the thread of the nut by turning the nut to secure the component to the support.

FIG. 8 shows a schematic representation of steps of a method according to an embodiment of this invention.

FIG. 8 shows steps of a method for removing a component secured to a support.

The method comprises the steps:
providing T1 a nut according to any one of the claims 1-15 in its closed position at the component, wherein the component has a male thread matching the thread of the nut, and wherein the thread of the nut engages with the male thread of the component,
actuating T2 the thread of the nut by rotating the nut to remove the component from the support until the nut is in its open position, and
sliding T3 the nut in its open position over the male thread of the component to remove the component from the support.

In summary, at least one embodiment of this invention has at least one of the features listed below and/or provides at least one of the advantages listed below:
Simple, inexpensive and quick assembly and disassembly.
simple, inexpensive manufacture.
Few components for the nut.
“Self-locking” nut.

Although this invention has been described with reference to preferred exemplary embodiments, it is not limited thereto and can be modified in a variety of ways.

### LIST OF REFERENCE NUMERALS AND TERMS

1 nut
2 first nut part
2a rim surface
3 second nut part
3a projection
4 threaded lug
4a initial area threaded lug
4b end area threaded lug
5 thread
6 link
6a rounding link
7 link element
7a rounding link element
8 return device
9 spring
10 thread flanks
20, 21 areas
50 component/sanitary faucet
50a male thread
51 support/countertop
52 intermediate element/stabilization
triangle
53 elastic element/rubber disk
54 solid element/metal disk
91 first angle
92 second angle
100 system
101 axial direction
102 radial direction
103 direction of determination
201 open position
202 closed position
S1-S6 steps of a method
T1-T3 steps of a method

1. A nut (1) for securing a component (50) to a support (51), in particular a sanitary faucet to a countertop, comprising
a first nut part (2), and
a second nut part (3), wherein
the first nut part (2) has at least two threaded lugs (4), which have a thread (5) on their radially inner face, wherein the threaded lugs (4) are arranged projecting radially outward at a first angle (91), and wherein the two nut parts (2, 3) are arranged axially displaceably (101) relative to each other such that in a first position—open position (201)—, the threaded lugs (4) of the first nut part (2) are arranged projecting radially outward, and that in a second position—closed position (202)—, the threaded lugs (4) of the first nut part (2) are pressed radially inward by means of the second nut part (3) for engaging with a matching male thread (50a) of the component (50).

2. The nut (1) according to claim 1, characterized in that the first (2) and second nut parts (3) are secured to each other by means of a securing device (6, 7), which in particular is designed to be detachable.

3. The nut (1) according to claim 2, characterized in that the securing device (6, 7) comprises a latching, clipping or snapping device.

4. The nut (1) according to claim 1, characterized in that a return device (8) is arranged to exert a return force in the direction of the open position (201).

5. The nut (1) according to claim 4, characterized in that the return device (8) comprises a spring device having at least one spring (9) arranged between the first nut part (2) and the second nut parts (3).

6. The nut (1) according to claim 4, characterized in that the return device (8) comprises mutually matching surfaces (20, 21) on first and second nut parts (2, 3), which surfaces can slide along other and are beveled at a second angle (92) with respect to the axial direction (101).

7. The nut (1) according to claim 1, characterized in that the second angle (92) is greater than the first angle (91).

8. The nut (1) according to claim 6, characterized in that the second angle (92) relative to the axial direction (101) is at least 5 degrees, in particular at least 10 degrees, preferably at least 15 degrees, in particular at least 30 degrees.

9. The nut (1) according to claim 1, characterized in that the first angle (91) of the threaded lugs (4) relative to the axial direction (101) is at least 0.1 degrees, in particular at least 0.5 degrees, preferably at least 1 degree, in particular at least 3 degrees.

10. The nut (1) according to claim 1 characterized in that the number of threaded lugs (4) is less than 30, preferably less than 15, in particular less than 8, preferably 4.

11. The nut (1) according to claim 1, characterized in that thread flanks (10) of the thread (5) of at least one of the threaded lugs (4), in particular of each threaded lug (4), are shortened in the area facing away from the end area (4b) of the at least one thread lug (4), in particular wherein the area (4a) comprises more than one thread flank (10) and/or less than 5 thread flanks (10), preferably 2 thread flanks (10) of the thread (5).

12. The nut (1) according to claim 1, characterized in that guide devices (6, 7) are arranged for the defined guidance of first and second nut parts (2, 3) along each other, in particular wherein the guide devices (6, 7) are designed as locating devices.

13. The nut (1) according to claim 12, characterized in that the guide device (6, 7) comprises a link device having at least one link (6) and one link element (7), in particular wherein the link element (7) is arranged on the first nut part (2).

14. The nut (1) according to claim 13, characterized in that a plurality of links (6) having link elements (7) are arranged, in particular wherein the number is more than 3 each and less than 6 each, preferably 4 each.

15. The nut (1) according to claim 13, characterized in that the at least one link element (7) and the link (6) are each rounded (6a, 7a).

16. system (100) for securing a component (50) to a support (51), comprising a nut (1) according to claim 1, wherein the component (50) has a male thread (50a) matching the thread (5) of the nut (1) such that in its closed position (202) the nut (1) can be screwed onto the male thread (50a), and wherein, in its open position (201), the thread (5) has, at least in one area (4b), an internal diameter that is greater than the external diameter of the male thread (50a).

17. The system according to claim 16, characterized in that, in the open position of the nut (1), the thread has, at least in one area (4a), an inner diameter that is smaller than or equal to the outer diameter of the male thread (50a).

18. A method of securing a component (50) to a support (51), comprising the steps of
providing (S1) a nut (1) according to claim 1 in the open position (201),
providing (S2) the component (50), wherein the component (50) has a male thread (50a) matching the thread (5) of the nut (1) such that in its closed position (202) the nut (1) can be screwed onto the male thread (50a),
arranging (S3) the component (50) at the support (51),
sliding (S4) the nut (1) in its open position (201) over the male thread (50a) of the component (50) until the second nut part (3) of the nut (1) rests against the support (51),
actuating (S5) the first nut part (2) until the nut (1) is in its closed position (202) to engage with the thread (5) in the male thread (50a) of the component (50), and
actuating (S6) the thread (5) of the nut (1) by turning the nut (1) to secure the component (50) to the support (51).

19. A method for removing a component (50) secured to a support (51), comprising the steps of
providing (T1) a nut (1) according to claim 1 in its closed position (202) at the component (50), wherein the component (50) has a male thread (50a) matching the thread (5) of the nut (1), and wherein the thread (5) of the nut (1) engages with the male thread (50a) of the component (50),
actuating (T2) the thread (5) of the nut (1) by rotating the nut (1) to remove the component (50) from the support (51) until the nut (1) is in its open position (201), and
sliding (T3) the nut in its open position (201) over the male thread (50a) of the component (50) to remove the component (50) from the support (51).
